(19) United States
(12) Patent Application Publication
(10) Pub. No.: US 2006/0109239 A1
(43) Pub. Date: May 25, 2006

(54) Integrated module combining cursor control and numeric keypad

(76) Inventor: Ta-Sung Hsiung, Jhongli City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/156,646

(22) Filed: Jun. 21, 2005

(30) Foreign Application Priority Data
Nov. 23, 2004 (TW) 93136021

(51) Int. Cl. G09G 5/00

(52) U.S. Cl. 345/156

(57) ABSTRACT

A peripheral device for computers or similar electronic devices includes a combination of a cursor controller, such as computer mouse, including a displaceable casing and a numeric keypad having at least one functional key and a plurality of numeric keys formed on a surface of the casing. A displacement detection mechanism is arranged inside the casing to detect the displacement of the casing. A control circuit converts the detected displacement into displacement signals transmitted through a cable or a wireless communication device to a computer, which in turn controls the movement of a screen cursor. The control circuit is reversibly switchable from the cursor control mode into a keypad mode in which the control circuit receives actuation of the keys and applies corresponding signals to the computer device.

### FIELD OF THE INVENTION

The present invention relates generally to a peripheral device of computers, and in particular to an integrated module combining a numeric keypad with a cursor controller or tracking device.

### BACKGROUND OF THE INVENTION

With the development of computer technology and digitalized multi-medium technology, computer devices are widely used in a variety of applications, such as office applications, home entertainments, and business operations. Interfacing between the computers and computer operators are often realized by peripheral devices, such as a keypad and a cursor controller or tracking device, for example a computer mouse. The conventional computer mouse comprises control buttons that allows the computer operator to perform screen operations on a display screen of the computer, including screen clicking, selection and execution of screen icons, and screen scrolling.

The computer mouse is often categorized as mechanical mouse, semi-optic mouse, and optic mouse, all functioning to control the movement of a screen cursor and selection or clicking of screen icons. On the other hand, a keypad, such as numeric keypad, comprises a number of keys or pushbuttons each associated with a specific character, such as numeric keys and alphabetic keys, which allow the computer operator to key in numbers and characters in a straightforward manner.

To enhance the operation of the computer, the computer operator often needs to control and operate both the cursor controller and the keypad or keyboard. This, to some extents, is troublesome for the computer operator, especially for those needing to frequently key in numbers in for example accounting applications.

Thus, the present invention is aimed to provide a computer peripheral device that combines the cursor controller and the keypad together to overcome the problem discussed above.

### SUMMARY OF THE INVENTION

An objective of the present invention is to provide an integrated module combining cursor control and numeric keypad, which allows a computer operator to perform both cursor tracking, as well as screen operation, and figure entering with a single peripheral device.

Another objective of the present invention is to provide a computer peripheral that comprises numeric keys formed on a casing of a computer mouse whereby a single casing provides both functions of cursor tracking and figure entering.

To achieve the above objectives, in accordance with the present invention, an integrated module of computer peripheral device, that combines a cursor controller or tracking device, such as computer mouse, which includes a displaceable casing, and a numeric keypad, which has a plurality of numeric keys formed on a surface of the casing. A displacement detection mechanism is arranged inside the casing to detect the displacement of the casing. A control circuit converts the detected displacement into displacement signals transmitted through a cable or a wireless communication device to a computer, which in turn controls the movement of a screen cursor. The control circuit is reversibly switchable from the cursor control mode into a keypad mode in which the control circuit receives actuation of the keys and applies corresponding signals to the computer device

The present invention provides a computer peripheral device that combines a cursor tracking device and a numeric keypad together, whereby a computer operator may perform cursor tracking, as well as screen operation, and figure entering with a signal peripheral device, which simplifies the computer system constituted by the computer device and the peripheral devices and enhances operation of the computer device. Further, by coupling the peripheral device with the computer device with wireless transmission, the system can be even more simplified and operation better enhanced.

### BRIEF DESCRIPTION OF THE DRAWINGS

The present invention will be apparent to those skilled in the art by reading the following description of preferred embodiments thereof, with reference to the attached drawings, in which:

FIG. 1 is a perspective view of an integrated module combining a cursor controller and a numeric keypad constructed in accordance with a first embodiment of the present invention, in which a cable connects the integrated module to the computer device;

FIG. 2 is schematic view illustrating a computer device to which the integrated module of the present invention is connected;

FIG. 3 is a block diagram showing a control circuit of the integrated module of the present invention;

FIG. 4 is a schematic view illustrating a computer device to which an integrated module combining a cursor controller and a numeric keypad constructed in accordance with a second embodiment of the present invention wherein a wireless communication is employed to couple the integrated module to the computer device; and

FIG. 5 is a block diagram showing a control circuit of integrated module in accordance with the second embodiment of the present invention.

### DETAILED DESCRIPTION OF PREFERRED EMBODIMENT

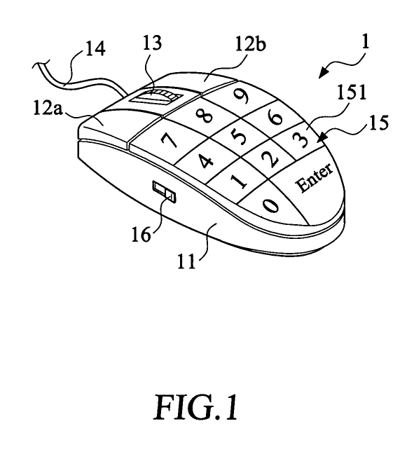

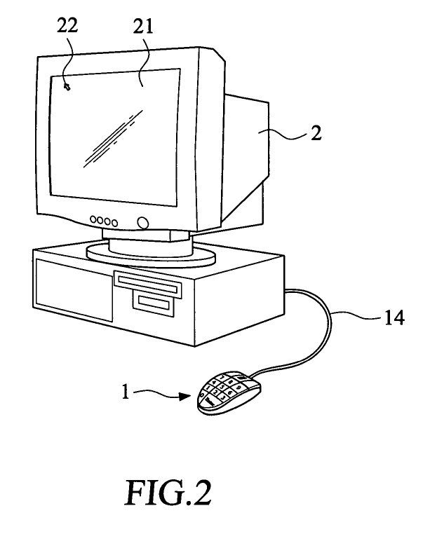

With reference to the drawings and in particular to FIG. 1, an integrated module combining cursor controller (or cursor tracking device) and numeric keypad constructed in accordance with the present invention, generally designated with reference numeral 1, comprises a cursor controller (cursor tracking) portion, such as a conventional computer mouse, comprising a casing 11 that is movable or slidable on a fixed surface, such as a desktop (not shown), and control buttons 12a, 12b and a roller 13 that are similar to the control buttons and roller of the conventional computer mouse. Similar to a conventional cabled computer mouse, a cable 14 connects the cursor controller portion to a computer device 2 (see FIG. 2).

Similar to the conventional computer mouse, a mechanical or optical displacement detection mechanism (not shown) is contained inside the casing 11 whereby when the casing 11 is moved along the fixed surface, displacement is detected and electric signals associated therewith are transmitted to the computer device 2 via the cable 14 to control the location of a cursor 22 on a display screen 21 of the computer device 2. The control buttons 12a, 12b and the roller 13 function to do screen control of the computer device 2, such as screen selection or clicking, selection and execution of screen icons, and screen scrolling. This is well known to those having ordinary skill in the field of computers and computer peripherals. Unless related to the innovation of the present invention, no further detail regarding the operation and construction of the tracking device will be given herein.

The present invention also comprises a numeric keypad portion 15 formed on a top surface of the casing 11, comprising regular numeral keys 151, including an “Enter” key, similar to those of the conventional numeral keypad. Thus, when a user actuates the keys 151 of the numeric keypad 15, numeric figures are entered into the computer device 2 via the cable 14 and, in most cases, displayed on the screen 21, just like the operation of a conventional numeric keypad. It is quite apparent to those having ordinary skills to replace some of or all the numeric keys 151 with other keys, such as alphabetic keys, or simply adds additional keys to the keypad 15.

To this end, two conventional computer peripherals are combined as a single module, which comprises two different operation modes, namely cursor control (tracking) mode and keypad mode. A mode selection switch 16 is provided on the casing 11, which allows the user to select and switch between the cursor controller and the numeric keypad.

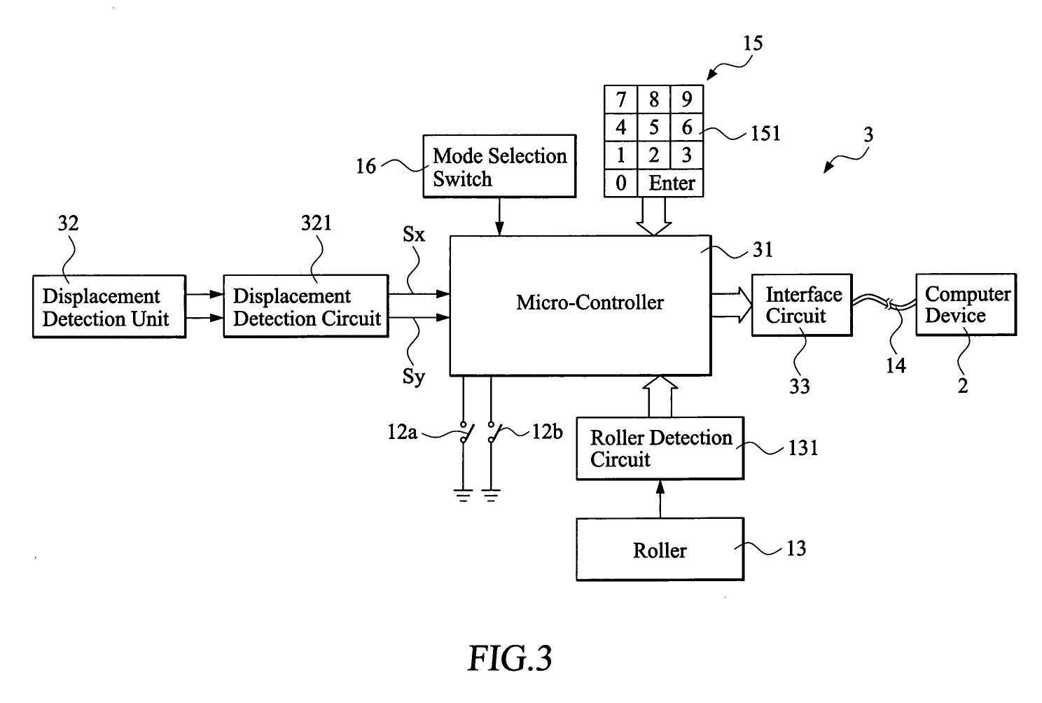

Also referring to FIG. 3, the integrated module 1 of the present invention comprises a control circuit, generally designated with reference numeral 3, comprising a micro-controller 31 that is coupled to the cable 14 and thus the computer device 2 by an interface circuit 33. The micro-controller 31 is electrically coupled to the cursor control buttons 12a, 12b to detect actuation of the buttons 12a, 12b. The micro-controller 31 is also connected to a roller detection circuit 131, which detects the rotation of the roller 13 and generates corresponding signals to the micro-controller 31.

A displacement detection unit 32, including an X-axis displacement mechanism and a Y-axis displacement mechanism, is arranged inside the casing 11. The control circuit 3 comprises a displacement detection circuit 321 that is coupled with the displacement detection unit 3 to detect the X-axis displacement and the Y-axis displacement and generate corresponding X-axis and Y-axis displacement signals (Sx and Sy) to the micro-controller 31. The displacement detection unit 32 can be of mechanical type or optical type.

The mode selection switch 16 is coupled to the micro-controller 31. When the mode selection switch 16 selects the cursor control mode, the micro-controller 31 transmits the displacement signals Sx and Sy to the computer device 2 via the interface circuit 33 and the cable 14, which are then used by the computer device 2 to control the location and movement of the cursor 22 on the screen 21. The control signals associated with the control buttons 12a, 12b and the roller 13 are also transmitted by the micro-controller 31 to the computer device 2 to control the screen operation of the computer device 2. Thus, the integrated module 1 of the present invention, when set to the cursor control mode, serves as a regular computer mouse.

The numeric keys 151 of the numeric keypad 15 are connected to the micro-controller 31. When the mode selection switch 16 selects the numeric keypad mode, the micro-controller 31 transmits the associated figure-entering signal of the numeric keys 151 to the computer device 2 via the interface circuit 33 and the cable 14. The micro-controller 31 can be operated, either in software manner or hardware manner, to selectively disable one of the two modes when the other mode is selected. Or alternatively, the micro-controller 31 may be set to simultaneously receive and apply the electrical signals associated with both modes to the computer device 2.

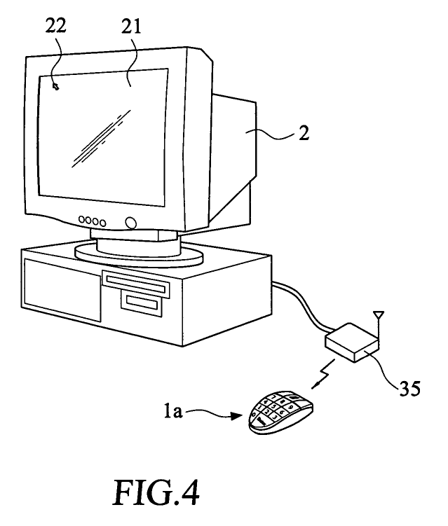

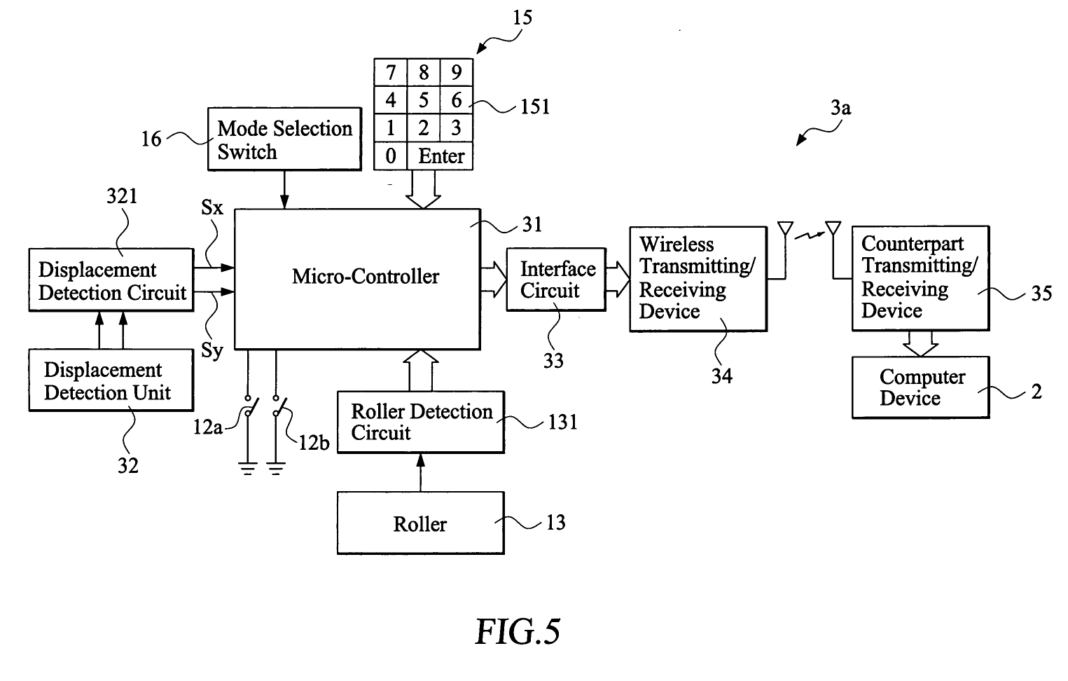

Referring to FIGS. 4 and 5, the integrated module that combines a cursor controller with a numeric keypad in accordance with the present invention can be in communication with the computer device 2 in a wireless manner, rather than by using a cable 14. In the embodiment illustrated in FIGS. 4 and 5, the integrated module, which is designated with reference numeral la for distinction, is substantially similar to the integrated module 1 illustrated in FIGS. 1-3, but instead of using a cable 14 connecting between the module 1 and the computer device 2 as shown in FIGS. 1 and 2, the control circuit of the module la, which is designated with reference numeral 3a in FIG. 5, comprises a wireless transmitting/receiving device 34 that is electrically coupled to the interface circuit 33 whereby the signals to be transmitted/received by the interface circuit 33 to/from the computer device 2 is processed and transmitted/received in a wireless manner by the wireless transmitting/receiving device 34. A counterpart transmitting/receiving device 35 is coupled to the computer device 2 for operative cooperation with the transmitting/receiving device 34 of the micro-controller 31 to transmit electric signals in either a one-way or two-way manner between the micro-controller 31 of the integrated module 1a and the computer device 2.

The wireless transmitting/receiving devices 34, 35 can be of any known devices, such as a radio frequency (RF) transmitter/receiver and an infrared (IR) transmitter/receiver. In the case of RF transmitter/receiver, preferably, both the transmitting/receiving devices 34, 35 are provided with antennas for transmitting and receiving electromagnetic waves that carry the signals to be transmitted between the module 1a and the computer device 2.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An integrated module combining cursor control and numeric keypad, comprising:
a displaceable casing;
a displacement detection mechanism arranged inside the casing to detect the displacement of the casing and generate displacement signals associated therewith;
a keypad comprising a number of numeric keys formed on a surface of the casing, which numeric keys are actuateable to generate associated key-entering signals; and
a control circuit arranged inside the casing and in electrical connection with the displacement detection mechanism and the keys of the keypad and comprising an interface for signal communication with a computer device;
wherein the control circuit is switchable between a first mode where the displacement signals are transmitted to the computer device and a second mode where the key-entering signals are transmitted to the computer device.

2. The integrated module as claimed in claim 1 further comprising a mode selection switch for switching the control circuit between the first and second modes.

3. The integrated module as claimed in claim 1 further comprising at least one control button adapted to perform screen operation on a screen of the computer device.

4. The integrated module as claimed in claim 1 further comprising a roller adapted to perform screen scrolling of a display screen of the computer device.

5. The integrated module as claimed in claim 1 further comprising a cable adapted to connect the interface of the control circuit to the computer device for signal communication between the control circuit and the computer device.

6. The integrated module as claimed in claim 1 further comprising a wireless communication device connected to the interface of the control circuit for signal communication with a counterpart wireless communication device coupled to the computer device.

7. The integrated module as claimed in claim 1, wherein the keypad further comprises an enter key.
